(19) United States
(12) Patent Application Publication
(10) Pub. No.: US 2015/0022334 A1
(43) Pub. Date: Jan. 22, 2015

(54) PROGRESSIVE ALERT SYSTEM FOR VEHICLE RESERVOIR FLUID FILL LEVEL

(71) Applicant: Deere & Company, Moline, IL (US)

(72) Inventors: Christopher L. Guillory, Peosta, IA (US); Michael J. Schmidt, Dubuque, IA (US)

(73) Assignee: Deere & Company, Moline, IL (US)

(21) Appl. No.: 13/946,893

(22) Filed: Jul. 19, 2013

(51) Int. Cl. B60Q 11/00

(52) U.S. Cl. CPC B60Q 11/00
USPC 340/450

(57) ABSTRACT

A system provides a progressive feedback alert of reaching a pre-determined fluid level in a reservoir of a work vehicle during filling. The system includes a fill level sensor coupled to the reservoir to detect the rising fluid level during filling and is configured to output real time fill level signals based on the changing instantaneous level of fluid in the reservoir. The system can also have a fluid temperature sensor that outputs a temperature signal based on the fluid temperature in the reservoir. The system also includes a control unit coupled to the fill level and temperature sensors that executes control software to analyze the fill level and temperature signals and output feedback signals proportionate to the instantaneously reservoir fluid levels. Further, the system includes a feedback device connected to the control unit to effect a progressive feedback alert based on the received feedback signals.

### CROSS-REFERENCE TO RELATED APPLICATION(S)

Not applicable.

### STATEMENT OF FEDERALLY SPONSORED RESEARCH OR DEVELOPMENT

Not applicable.

### FIELD OF THE DISCLOSURE

This disclosure relates to work vehicles, and in particular to a system for providing user feedback of the fill levels of onboard fluid reservoirs in work vehicles.

### BACKGROUND OF THE DISCLOSURE

Motorized vehicles, such as work vehicles used in the construction and forestry industries, have reservoirs that hold various fluids, such as coolant, fuel, engine oil and hydraulic oil, that must be maintained and refilled on a regular basis. Conventional work vehicles are equipped with some type of mechanical or electrical device that indicates the level of fluid in the reservoir. For viscous fluids, for example, the device may be a conventional dip stick with graduated markings that can be inserted into and removed from the reservoir to take a measured sample of the fluid indicative of the level of fluid in the reservoir. The device could also be a sight gauge in the form of a window in the wall of the reservoir with or without graduated markings that gives a direct line of sight into the reservoir. The device could also be a conventional mechanical level sensing mechanism with a movable needle gauge or an electromechanical level sensor arrangement that sends an electrical signal to a dedicated electronic gauge or display interface.

All of the aforementioned devices are best suited for indicating the fluid level of a reservoir at some point after it is filled with the fluid, and are cumbersome or ineffective to use while adding fluid to the reservoir. For example, dip sticks require the filler to frequently stop adding fluid to the reservoir to take dip stick readings in order to determine whether the maximum or other appropriate fill level was been reached. This process is time consuming and can lead to over-filling the reservoir. Sight gauges can be difficult to view while filling as well since, particularly in heavy-duty work vehicles, they are ordinarily hidden beneath vehicle body panels or dedicated guards in order to protect the gauge from hazards of the operating environment. And if not hidden, sight gauges are susceptible to being damaged, which could also inhibit the operation of the vehicle if the reservoir is compromised. Lastly, mechanical or electromechanical devices that are read at gauges in the instrument cluster or display interface in the vehicle cabin either require the filler to stop filling to check readings in the cabin or require an additional person to assist in filling the reservoir.

An additional problem with some fluid reservoirs in work vehicles is determining the correct fill level when the desired fill level is less than the maximum capacity of the reservoir such that both automatic shut-off systems and visual inspection of the filling orifice are not effective. Further, in some cases the desired fill level varies depending on certain operating conditions. For example, the desired fill level of a hydraulic oil tank varies depending on whether the fluid is hot or cold because the thermal expansion of the oil that occurs during operation requires an air space to be left in the reservoir to accommodate for the additional volume occupied by the fluid at elevated temperatures. As a result, the reservoir can be effectively over filled when the system is at elevated temperatures or under filled at lower temperatures, even if the fluid is filled to a constant height within the reservoir.

This disclosure addresses the aforementioned problems.

### SUMMARY OF THE DISCLOSURE

This disclosure provides a system to assist a vehicle operator, mechanic or other worker in adding the proper amount of fluid to a fluid reservoir onboard a work vehicle. The system provides a user feedback alert or alarm that progresses in intensity as the fluid level rises within the reservoir during the filling process. The alert can be visual, audible or tactile, and can use system-dedicated controls, interfaces and feedback devices or be incorporated in already existing components of the work vehicle.

As one example, when someone fills an onboard fluid reservoir, an audible alert, such as a horn of the work vehicle, can sound with increased frequency and amplification as the fluid level approaches the desired fill level. Alternatively or additionally, a visual alert, such as activation of the work vehicle work light or headlights, can illuminate with increased frequency and luminescence as the fluid level approaches the desired fill level. The progressive feedback alert system disclosed herein is a particularly effective aid in filling reservoirs with sub-maximal or varied desired fill levels, such as a hydraulic oil tank.

The progressive alert system can include as main components a fill level sensor, an electronic control unit and a feedback device. The fill level sensor is coupled to the control unit which provides a progressive feedback signal to the feedback device to generate a user alert that is proportional to the fluid level in the reservoir. A fluid temperature sensor can also be coupled to the control unit to take into account different temperature-dependent fill levels when generating the alert feedback. A user interface display can also be coupled to the control unit to output sensor information and allow for user selection of system settings.

Thus, in one aspect, this disclosure provides a system for providing a progressive feedback alert of reaching a pre-determined fluid level in a fluid reservoir during filling of the reservoir, in which the system includes: a fill level sensor coupled to the reservoir to detect the rising fluid level within the reservoir during filling of the fluid in the reservoir, the fill level sensor configured to output real time fill level signals based on the changing instantaneous level of fluid in the reservoir; a control unit communicatively coupled to the fill level sensor to receive the fill level signals and configured to execute control software to analyze the fill level signals received from the fill level sensor and output feedback signals that are proportionate to the instantaneously levels of fluid in the reservoir; and a feedback device communicatively coupled to the control unit to effect an alert based on the feedback signals received from the control unit, wherein one or more parameters of the alert progressively changes as the reservoir fluid level rises.

In another aspect, this disclosure provides a system for providing a progressive feedback alert of reaching a pre-determined fluid level in a fluid reservoir during filling of the reservoir, in which the system includes: a fill level sensor coupled to the reservoir to detect the rising fluid level within the reservoir during filling of the fluid in the reservoir, the fill level sensor configured to output real time fill level signals based on the changing instantaneous level of fluid in the reservoir; a fluid temperature sensor coupled to the reservoir and configured to output a temperature signal to the control unit based on a temperature of the fluid in the reservoir; and a control unit communicatively coupled to the fill level sensor to receive the fill level signals and to the temperature sensor to receive the fluid temperature signal, wherein the control unit is configured to execute control software to analyze the temperature signal from the temperature sensor and the fill level signals from the fill level sensor and output feedback signals that are proportionate to the instantaneous levels of fluid in the reservoir, and wherein the output feedback signals differ based on whether the temperature signal is within a first temperature range corresponding a first pre-determined fluid fill level or within a second temperature range corresponding to a second pre-determined fluid fill level; and a feedback device communicatively coupled to the control unit to effect an alert based on the feedback signals received from the control unit, wherein one or more parameters of the alert progressively changes as the reservoir fluid level rises.

In another aspect, this disclosure provides in a work vehicle having a system for providing a fluid fill level user feedback alert, in which the system includes: a fluid reservoir configured to receive a fluid up to a pre-determined fluid fill level; a fill level sensor coupled to the reservoir to detect the rising fluid level within the reservoir during filling of the fluid in the reservoir, the fill level sensor configured to output real time fill level signals based on the changing instantaneous level of fluid in the reservoir; a control unit communicatively coupled to the fill level sensor to receive the fill level signals and configured to execute control software to analyze the fill level signals received from the fill level sensor and output feedback signals that are proportionate to the instantaneous levels of fluid in the reservoir; a feedback device communicatively coupled to the control unit to effect an alert based on the feedback signals received from the control unit, wherein one or more parameters of the alert progressively changes as the reservoir fluid level rises; and a user interface coupled to the control unit to display the state of the feedback device and provide user input to set one or more parameters of the alert.

Still other features of the progressive feedback alert system will be apparent from the following description and accompanying drawings.

### BRIEF DESCRIPTION OF THE DRAWINGS

FIG. 1 is a side elevational of a work vehicle in the form of a grapple skidder having a progressive feedback fluid fill level alert system according to this disclosure;

FIG. 2 is an enlarged perspective view of an engine cover thereof to which is mounted a hydraulic fluid reservoir;

FIG. 3 is partial perspective view thereof with panels of the engine cover removed to reveal the reservoir;

FIG. 4 is a perspective view of the reservoir showing a fill level sensor and a fluid temperature sensor coupled to an electronic control unit;

FIG. 5 is a front elevational view thereof;

FIG. 6 is a side cross-sectional view of taken along line 6-6 of FIG. 5;

FIG. 7 is an elevational view of an example fluid level sending unit; and

FIG. 8 is a schematic diagram of an example progressive feedback fluid fill level alert system.

### DETAILED DESCRIPTION

The following describes one or more example constructions of a progressive feedback fluid fill level alert system 10, as shown in the accompanying figures of the drawings described briefly above. Various modifications to the example construction(s) may be contemplated by one of skill in the art.

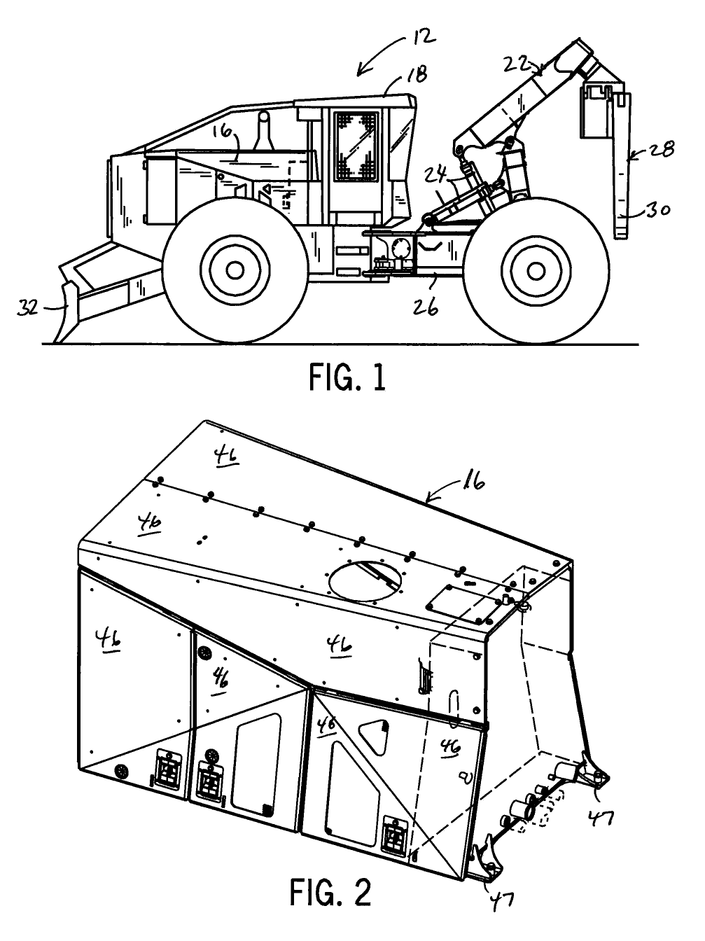

The progressive feedback alert system 10 can be used advantageously with any of various types of existing vehicles, including many of the agricultural, construction and forestry machines commercially available from Deere & Co. of Moline, Illinois. For simplicity, FIG. 1 shows one example application of the progressive feedback alert system 10 incorporated into a particular work vehicle used in the forestry industry known as a grapple skidder 12 to assist in filing a hydraulic fluid reservoir or oil tank 14. However, the principles disclosed herein could be incorporated into both powered pedestrian and work vehicles having any type of fluid system, such as engine fuel, oil and coolant, cleaner fluid and hydraulic fluid. As such, the terms “work vehicle” and “reservoir” are not to be interpreted as limiting or limited to the illustrated grapple skidder and hydraulic oil tank described herein. Moreover, the progressive feedback alert system 10 may be installed as an original factory component of the work vehicle or retrofit to a reservoir of an pre-existing vehicle.

Referring now to FIGS. 1-3 of the example embodiment, the skidder 12 has a body defining an engine cover 16 and a cabin 18 and a pivoting boom assembly 22 driven by hydraulic cylinders 24, all of which is supported by an articulating chassis 26. A grapple 28 is suspended from the boom assembly 22 which has tongs 30 that a vehicle operator can articulate using onboard controls (not shown) in the cabin 18 to clamp around felled trees, for example, that are to be dragged away by the skidder 12. Also, attached to the front of the chassis 26 is a front implement 32, shown in the illustrated example as a plow blade.

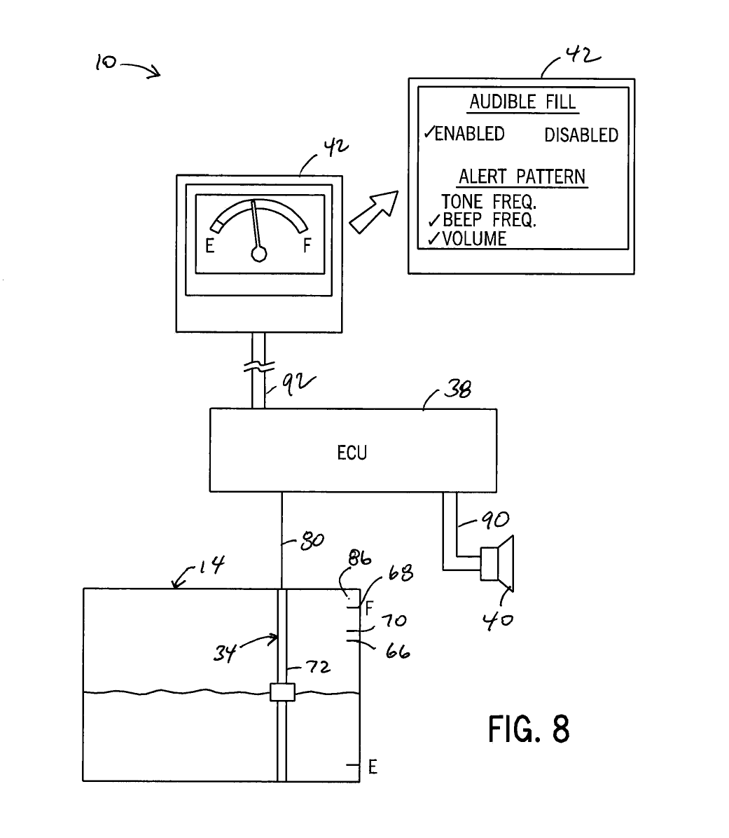

The progressive feedback alert system 10 couples between the hydraulic oil tank 14 and a user interface within the interior (not shown) of the cabin 18. Generally, as shown schematically in FIG. 8, the example progressive feedback alert system 10 includes as main components a fill level sensor 34, a fluid temperature sensor 36, a control unit 38, a feedback device 40 and a user interface 42.

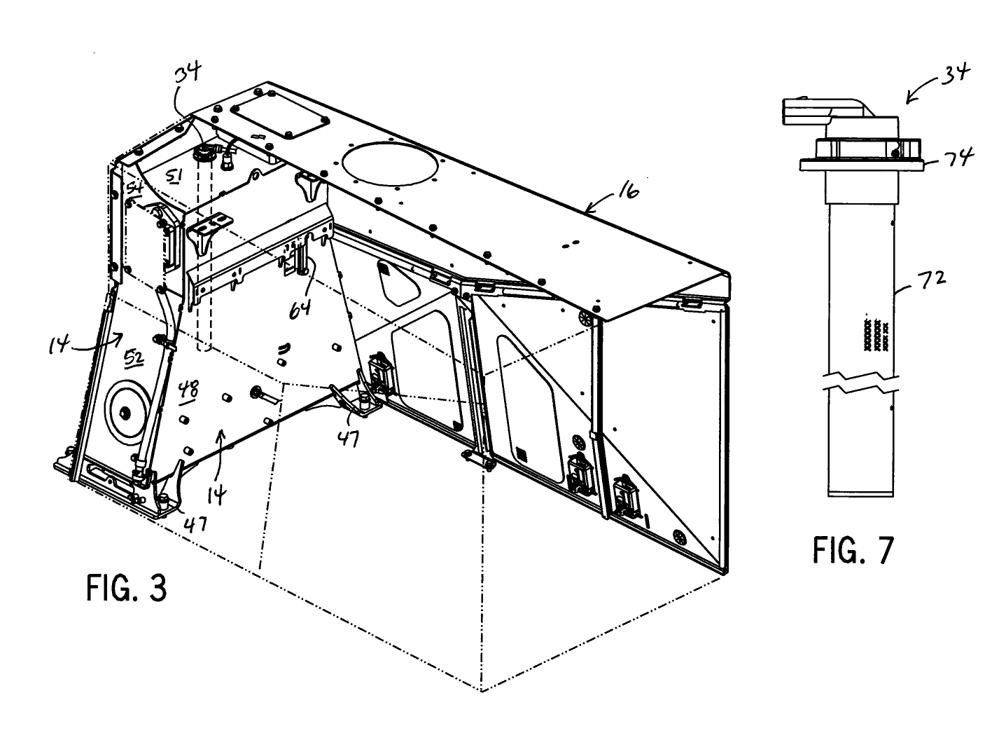

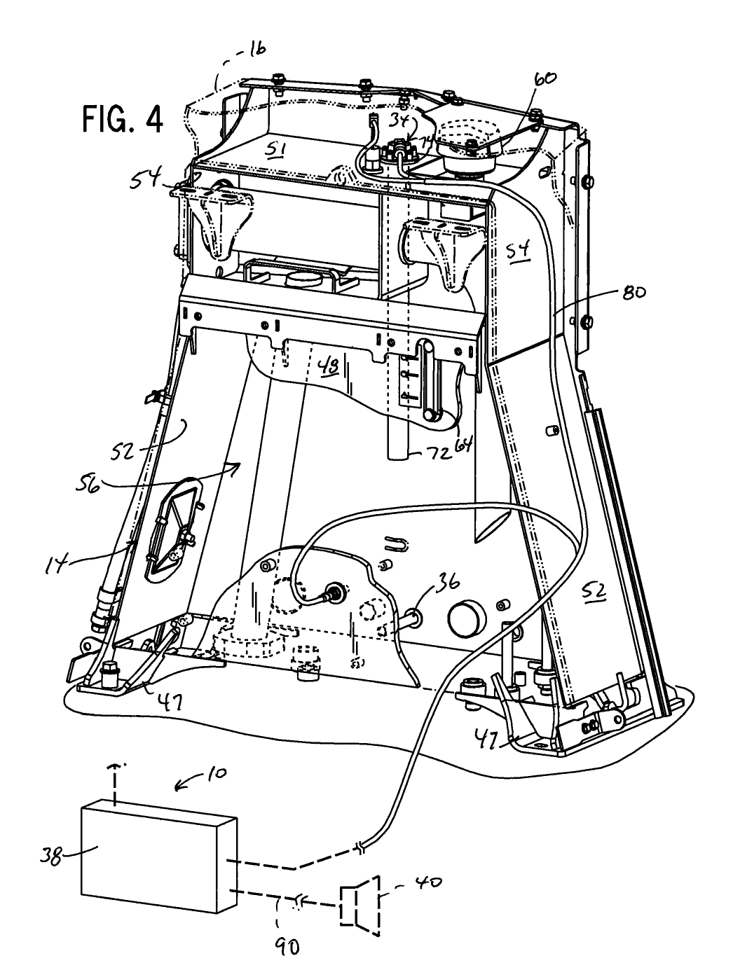

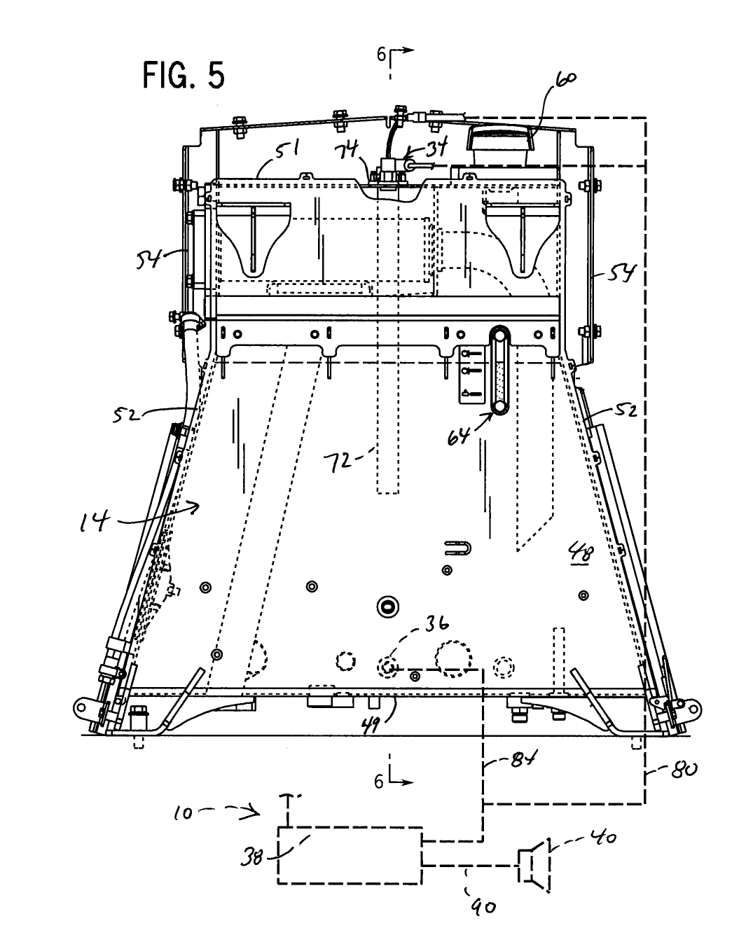

Specifically, with reference to FIGS. 3-6, the hydraulic oil tank 14 is mounted within the inside of the engine cover 16, which is constructed of sheet metal panels 46 and mounted to the front end of the skidder chassis 26. The hydraulic oil tank 14 is constructed of a front wall 48, a rear wall 50, two angled side walls 52 coupled to two vertical side walls 54, a base 49, and a top wall 51 which, together, define a hollow cavity 56. The walls 48, 49, 50, 51, 52, 54 may be joined together by welding, for example, or another suitable connection technique. The hydraulic oil tank 14 can be fastened to the skidder chassis 26 by brackets 47 that are bolted, for example, to the base 49 of the hydraulic oil tank 14 and the chassis 26. The hollow cavity 56 of the hydraulic oil tank 14 is configured to receive a fluid, such as hydraulic oil, through an opening that is accessed by removing cap 60, as best shown in FIG. 4. As is conventional, the hydraulic oil is routed from the hydraulic oil tank 14 through fittings at the rear of the tank that couple to low pressure hydraulic plumbing lines (not shown) connected to a hydraulic pump (not shown). The hydraulic pump is in turn coupled to the hydraulic cylinders 24 via high pressure hydraulic plumbing lines (not shown) to actuate the boom assembly 22 via operator control of the hydraulic valve arrangement (not shown). Attached to the front wall 48 of the hydraulic oil tank 14 is a back-up visual sight gauge 64. The visual sight gauge 64 provides a direct sight line to the fluid inside the cavity 56 of the hydraulic oil tank 14. As shown in FIGS. 3 and 4, the sight gauge 64 is protected from the hazards of the operating environment by the engine cover 16.

The details of the example progressive feedback alert system 10 will now be described with continuing reference to FIGS. 4-8. As mentioned, the example progressive feedback alert system 10 includes the fill level sensor 34, temperature sensor 36, control unit 38, feedback device 40 and user interface 42. The fill level sensor 34 can be provided by a conventional fuel or oil level sending unit, such as the tube style sending unit shown in FIG. 7 and commercially available from ISSPRO, Inc. of Portland, Oregon. More specifically, the level sending unit has an elongated tube 72 and an enlarged flange 74 for mounting the unit to the hydraulic oil tank 14 with the tube 72 being positioned within the cavity 56. Inside the tube 72 is an internal float (not shown) which rises and falls with the fluid in the cavity 56, the position of which is sensed by onboard electronics (not shown) to which is connected an electrical wire 80 that couples the sending unit to the control unit 38. As is known, the level sending unit transmits an electrical signal to the control unit 38 indicative of the height position of the float. For example, when the float is near the top of the hydraulic oil tank 14, the resistance can be relatively low such that a relatively high current or voltage passes through the level sending unit, which generates and sends a corresponding output signal to the control unit 38. As the fluid level in the tank drops, the float sinks and the electrical properties change, for example the resistance may increase and the current may decrease, and thus the level sending unit generates and sends a corresponding output signal to the control unit 38. In this manner, the level sending unit outputs real time fluid fill level signals that are in proportion to the changing instantaneous levels of fluid in the hydraulic oil tank 14.

It should be noted that other conventional mechanical or electromechanical devices could serve as the fill level sensor 34, including resistive pad and wiper level sensor mechanisms and reed switch level sensor mechanisms. For example, the fill level sensor 34 can be a reed switch level sensor that consists of one or more reed switches positioned within a stationary non-metallic tube and one or more magnetic elements mounted on a float encircling the stationary tube. As the float rises and falls with the fluid level, the magnetic field generated by the magnets on the float actuates the hermetically sealed magnetic reed switch mounted within the tube which generates a corresponding output signal that can be transmitted to the control unit. Multi-station versions of these sensors allow for multiple level points to be monitored by using a separate reed switch for each level point (such as the pre-determined intermediate fill levels 66, 70 and the maximum capacity fill level 68 discussed below).

The progressive feedback alert system 10 can be configured to monitor a single fill level, such as a maximum capacity fill level 68 corresponding to at or near the full volume of the reservoir, or alternatively some intermediate fill level less than the maximum fill level 68. Monitoring a single fill level would typically suffice for fuel tanks or other reservoirs that hold fluids that do not undergo an appreciable change volume under different operational or environmental conditions. In such cases, the temperature sensor 36 could be omitted, or the control unit 38 could be configured to ignore its output signals.

However, the described example of the progressive feedback alert system 10 is particularly suited to monitor not only a sub-maximal fill level, but also multiple fill levels, which are often needed in reservoirs that hold fluids that expand in volume under working conditions, such as in the manner hydraulic oil expands volumetrically under elevated temperature conditions. Thus, the example progressive feedback alert system 10 can be configured to generate alerts based the desired fill level at different temperatures of the fluid. For instance, the system can provide an alert when the fluid level of the hydraulic oil tank 14 has reached a first pre-determined fill level 66 when the fluid is within a first temperature range as well as when the fluid has reached a second pre-determined fill level 70 when the fluid is within a second temperature range. The fill levels 66, 70 could both be intermediate, or sub-maximal, fill levels, as shown in FIG. 8, or one of the fill levels 66, 70 could be the same as the maximum capacity fill level 68. In the described example, the first pre-determined intermediate fill level 66 corresponds to a “cold” temperature range in which the hydraulic oil is at or near ambient temperature, such as in the range of 40-100° F., and the second pre-determined fill level 70 corresponds to a “hot” temperature range in which the hydraulic oil is at elevated temperatures consistent with operation of the work vehicle and hydraulic system, such as in the range of 80-180° F. It should be noted that the in the described example the pre-determined fill levels 66, 70, and even the maximum capacity fill level 68, are located below the top of the hydraulic oil tank 14 to provide an air space 86 that accommodates for the thermal expansion of the hydraulic oil. Therefore, in practice the hydraulic oil tank 14 would not be filled to its actual full capacity with hydraulic oil, but rather less some discreet volume of air space.

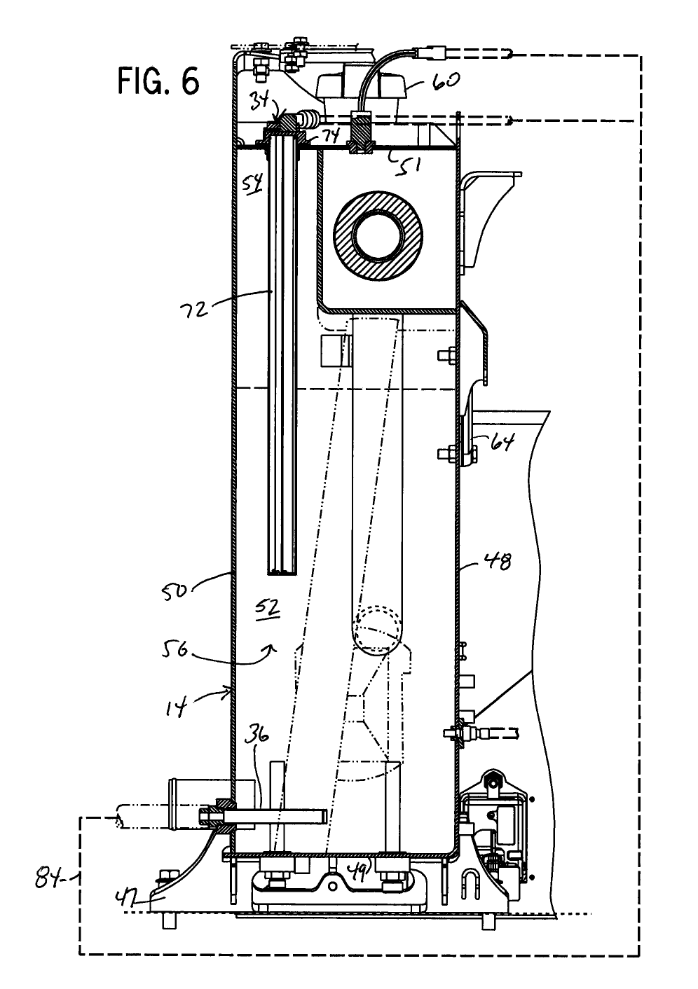

The temperature of the hydraulic oil within the hydraulic oil tank 14 is determined by the fluid temperature sensor 36, which can be cantilever-mounted through the rear wall 48 of the hydraulic oil tank 14 to physically extend into the tank cavity 56 in contact with the fluid therein, as shown in FIG. 6. Any suitable corrosion-resistant temperature probe or thermocouple can be used, such as a suitable temperature sender available from ISSPRO, Inc. of Portland, Oregon. The fluid temperature sensor 36 is coupled to a temperature signal wire 84 connected to the control unit 38 to send output temperature signals to the control unit 38 based on the sensed temperature of the hydraulic oil inside the hydraulic oil tank 14.

The control unit 38 of the progressive feedback alert system 10 can be a dedicated electronic control unit, or it can be a pre-existing electronic control of the skidder 22, such as the vehicle master controller used to control the overall performance of the engine and vehicle sub-systems, or discreet control hardware for one or more specific sub-systems. The control unit 38 is configured to receive output fill level signals from the fill level sensor 34 and output temperature signals from the fluid temperature sensor 36. The level signal wire 80 and temperature signal wire 84 are communicatively coupled to the control unit 38, thereby delivering the output fill level signals and temperature signals to the control unit 38. The control unit 38 is programmed to execute control software to analyze both the fill level signals received from the fill level sensor 34 and the temperature signals received from the fluid temperature sensor 36 and generate output feedback signals that control the operation of the feedback device 40, which is communicatively coupled to the control unit 38 via suitable dedicated or common electrical lines or system bus 90. The control unit 38 generates feedback signals that are proportionate to the instantaneous levels of fluid in the hydraulic oil tank 14. In addition, the output feedback signals sent from the control unit 38 to the feedback device 40 take into account and can differ depending on whether the temperature signal is within the first or second temperature range, that is whether the hydraulic oil in the hydraulic oil tank 14 is “hot” or “cold.”

In other words, as the hydraulic oil tank 14 is being filled, the fluid level will begin to approach the pre-determined fluid fill levels. Assuming the control software has analyzed the temperature signal received from the fluid temperature sensor 36 as being within the first temperature range, or “cold,” as the fluid level approaches the pre-determined fill level 66, the fill level sensor 34 will generate real time fill level signals as the float of the fill level sensor 34 rises. The control unit 38 executes the control software to analyze the real time fill level signals from the fill level sensor 34 and outputs feedback signals to the feedback device 40 that are proportionate to the instantaneous levels of the fluid in the hydraulic oil tank 14. On the other hand, if the control software has analyzed the temperature signal received from the fluid temperature sensor 36 as being within the second temperature range, or “hot,” the pre-determined fill level 66 will be ignored such that as the fluid level approaches the pre-determined fill level 70, the fill level sensor 34 will generate real time fill level signals as a result of the float rising. Similarly, the control unit 38 executes the control software to analyze the real time fill level signals from the fill level sensor 34 and outputs feedback signals to the feedback device 40 that are proportionate to the instantaneous levels of the fluid in the hydraulic oil tank 14. Once the feedback device 40 begins receiving the feedback signals from the control unit 38, the feedback device 40 effects an alert based on these feedback signals. The feedback signals direct the feedback device 40 to progressively change the alert as the fluid level rises and approaches the pertinent pre-determined fill level 66, 70.

Note that the output feedback signals can, and likely will, differ depending on which of the different pre-determined fill levels 66, 70 (or maximum capacity fill level 68) the progressive feedback alert system 10 is monitoring. This is because a more urgent alert (i.e., higher frequency, amplitude, etc.) will be desired for at instantaneous fill level for the first pre-determined fill level 66, which is at lower tank height and volume and thus will be reached sooner than the second pre-determined fill level 70 (or maximum capacity fill level 68), which is at a higher tank height and volume.

The control unit 38 can be programmed to provide feedback signals to the feedback device 40 that are directly proportionate to the fill level signals from the fill level sensor 34. In other words, for every incremental change in a fill level related parameter, such as fill height, fill volume or fill rate, the control unit 38 can analyze the fill level signals and generate feedback signals to effect a corresponding incremental step change in the output of the feedback device 40. For example, as the hydraulic oil tank 14 is filled and the volume of fluid raises by a Δv, the control unit 38 can direct an audible feedback device to output an alert that is a Δa greater in amplitude, i.e., louder. Such one for one proportional feedback can be provided throughout the entire filling process, or only during a pre-determined portion of the filling process or at select fill levels, such as at lower fill levels.

Alternatively, the control unit 38 can be programmed to provide feedback signals to the feedback device 40 that are indirectly proportionate to the fill level signals from the fill level sensor 34. In this case, during the filling process, or a pre-determined portion thereof or select fill levels, such as higher fill levels, the control unit 38 can analyze the fill level signals and generate feedback signals to effect a change in the output of the feedback device 40 that is related to, but not directly proportional to, the change in a fill level parameter. For example, as the hydraulic oil tank 14 is filled and the volume of fluid raises by a Δv, the control unit 38 can direct the audible feedback device to output an alert that is a Δa +x greater in amplitude (louder). The “x” factor can be a constant value, or it can be a variable that is dependent on another fill level parameter or other exigent parameter, such as a temperature signal from the temperature sensor 36. In this example, the output alert might ramp up in amplitude greater than the incremental Δa step change mentioned above. Again, it could do this during all or only a pre-determined portion of the filling process, for example it could be employed to provide a heightened alert during higher fill levels approaching the pre-determined fill level 66, 70. The “x” factor could also affect an additional characteristic of the feedback device 40, such as in addition to amplitude to also change the frequency or pitch of an audible alert. The “x” factor could also be used to alter the period between each successive alert, either at a disproportionate time constant “t” or at a variable At, including where t=0 such as to effect a constant alert. Thus, in this way, the progressive alert system disclosed herein contemplates systems in which the feedback is both directly and indirectly proportionate to the fill level.

As mentioned, the feedback device 40 can be a separate device specifically dedicated to the progressive feedback alert system 10. Alternatively, the feedback device 40 can be a pre-existing vehicle component or sub-system. Moreover, the feedback 40 device can produce one or more of an audible, visual and tactile response as user feedback of the level of fluid in the reservoir.

For example, the alert generated by the feedback device 40 can be an audible alarm that proportionately increases in frequency and/or amplification as the fluid level in the hydraulic oil tank 14 rises and approaches the applicable pre-determined fill level 66, 70. The audible alert can be, but is not limited to, a beep or tone generated by the skidder's 12 horn or speaker system. Thus, as the hydraulic oil tank 14 is being filled with fluid, the skidder's 12 horn can beep, or the speaker system can generate a sound, for example a beep, tone or music, that gets progressively louder in proportion to the raising fluid level and in the case of a beep or tone can also increase in frequency, in terms of one or both of period and pitch, as the fluid level rises and approaches the applicable pre-determined fill level 66, 70 (or maximum capacity fill level 68).

As another example, the alert generated by the feedback device 40 can be a visual alert that proportionately increases in frequency and/or luminescence as the fluid level in the hydraulic oil tank 14 rises and approaches the pre-determined fill level 66, 70 (or maximum capacity fill level 68). The visual alert can be, but is not limited to, a light generated by an indicator light inside the cabin 18, or an exterior light such as the skidder's 12 work light, running lights, blinkers or headlights. As the hydraulic oil tank 14 is filled with fluid, the skidder's 12 light will generate a flash of light that gets progressively brighter and more frequent proportionately to the rising fluid level as it approaches the pre-determined fill level 66, 70 (or maximum fill level 68).

Thus, as mentioned, the alert generated by the feedback device 40 can be solely an audile alert, solely a visual alert, or a combination of both. And although not part of the aforementioned examples, a tactile feedback could be generated using a dedicated vibratory device that would vibrate a part of the vehicle. As described for the audible and visual alerts, the tactile alert can be generated to progressively increase in frequency and amplitude in proportion to the rising level of fluid in the reservoir.

The progressive feedback alert system 10 can also be configured with respect to the initiation and termination of the alert. Specifically, the progressive feedback alert system 10 can be configured to only activate the feedback device 40 upon reaching a threshold fill level, such as with a prescribed fill level below the applicable pre-determined or maximum fill level, for example when the fluid reaches 80% of the desired fill level. The progressive feedback alert system can be configured to activate upon reaching such a single threshold fill level regardless of whether there is a temperature input or whether it is taken into account to generate the feedback signals to the feedback device 40, as described above. Alternatively, there can be multiple threshold fill levels that the control unit 38 analyzes before initiating the alert. As an example, a first threshold fill level may correspond to 80 percent of the first pre-determined fill level 66, which is at a lower tank height and volume than for the second pre-determined fill level 70 (or maximum capacity fill level 68), which is at a higher tank height and volume and thus could have a second threshold fill level, corresponding to 80 percent of the second pre-determined fill level 70. Of course, each threshold fill level could be based on different percentages of full or other parameters related or unrelated to the pre-determined fill levels.

Additionally, once the fluid reaches the applicable pre-determined fill level 66, 70 (or maximum capacity fill level 68), a distinct change in the alert could be effected, including becoming a steady state constant or alternating feedback. For example, in the case of a visual alert, the light can become a solid, bright light, indicating to the user to stop filling the hydraulic oil tank 14, or for an audible alert, it can become a solid beep or tone. Or one type of alert, such as an audible only alert, could be alternated or combined with one or more other types of alerts, such as visual alert. Still further, other stimuli could be effected to get the user's attention such as by activating other sub-systems of the vehicle, for example, flashing the screen of the user interface or activating operator seat controls, window controls or door locks.

Like the other components, the user interface 42 of the progressive feedback alert system 10 can be a system-dedicated monitor or display panel, or it can incorporate the pre-existing vehicle operator interface display mounted in the cabin 18, for example a display interface such as the T7000 tablet commercially available from Mobile Demand of Hiawatha, Iowa. In either case, the user interface 42 is coupled to the control unit 38 via suitable electrical wires or bus 92 to give the vehicle operator an electronic display of the actual fill level in the hydraulic oil tank 14 as well as the fill levels of other vehicle fluids, such as fuel. The user interface 42 also allows the operator to readily enable, disable or check the state of activation of the progressive feedback alert system 10. It can also provide user input of one or more settings of the system, thereby allowing the operator to easily adjust various parameters of the alert system. For example, and without limitation, a vehicle operator can use the user interface 42 to select the type of alert, such as any one or combination of an audible, visual and tactile feedback response, and specific formats of each type, such as to activate the work light or the headlights, or to generate a tone, beep or play music. The user interface 42 could also be used to adjust parameters such as period frequency, pitch frequency and volume of audible alerts, the brightness and flashing frequency of visual alerts, and the frequency and amplitude of tactile alerts.

The foregoing detailed description describes the subject of this disclosure in one or more examples. A skilled person in the art to which the subject matter of this disclosure pertains will recognize many alternatives, modifications and variations to the described example(s). The scope of the invention is thus defined not by the detailed description, but rather by the following claims.

What is claimed is:

1. A system for providing a progressive feedback alert of reaching a pre-determined fluid level in a fluid reservoir during filling of the reservoir, the system comprising:
a fill level sensor coupled to the reservoir to detect the rising fluid level within the reservoir during filling of the fluid in the reservoir, the fill level sensor configured to output real time fill level signals based on the changing instantaneous level of fluid in the reservoir;
a control unit communicatively coupled to the fill level sensor to receive the fill level signals and configured to execute control software to analyze the fill level signals received from the fill level sensor and output feedback signals that are proportionate to the instantaneous levels of fluid in the reservoir; and
a feedback device communicatively coupled to the control unit to effect an alert based on the feedback signals received from the control unit, wherein one or more parameters of the alert progressively changes as the reservoir fluid level rises.

2. The system of claim 1, wherein the reservoir has a maximum capacity corresponding to a fluid fill level that is greater than the pre-determined fluid fill level.

3. The system of claim 1, wherein the control unit executes the control software to output feedback signals to the feedback device only after reaching a pre-determined threshold fluid fill level.

4. The system of claim 1, wherein the alert is an audible alarm that increases in at least one of frequency and amplification as the reservoir fluid level rises.

5. The system of claim 4, wherein the reservoir is on board a vehicle and wherein the feedback device is a vehicle horn.

6. The system of claim 1, wherein the alert is a visual alarm that increases in at least one of frequency and luminescence.

7. The system of claim 6, wherein the reservoir is onboard a vehicle and wherein the feedback device is at least one of an indicator light, a vehicle work light and a headlight of the vehicle.

8. The system of claim 1, further including a user interface coupled to the control unit to display feedback device information.

9. The system of claim 8, wherein the feedback device information displayed on the user interface includes an indication of the enabled state of the feedback device and one or more alert settings.

10. The system of claim 9, wherein the alert settings include selecting an audible alert or a visual alert and selecting one or more parameters of the alert.

11. The system of claim 1, wherein the reservoir is one of a fuel tank and a hydraulic oil tank.

12. The system of claim 1, further including a fluid temperature sensor coupled to the reservoir and configured to output a temperature signal to the control unit based on a temperature of the fluid in the reservoir.

13. The system of claim 12, wherein the control unit is configured to execute the control software to output different feedback signals to the feedback device based on whether the temperature signal received from the temperature sensor is within a first temperature range corresponding a first pre-determined fluid fill level or within a second temperature range corresponding to a second pre-determined fluid fill level.

14. The system of claim 13, wherein the control unit executes the control software to output feedback signals to the feedback device only after reaching a pre-determined threshold fluid fill level, and wherein the pre-determined threshold fluid fill level differs depending on whether the temperature signal is within the first or second temperature range.

15. A system for providing a progressive feedback alert of reaching a pre-determined fluid level in a fluid reservoir during filling of the reservoir, the system comprising:
a fill level sensor coupled to the reservoir to detect the rising fluid level within the reservoir during filling of the fluid in the reservoir, the fill level sensor configured to output real time fill level signals based on the changing instantaneous level of fluid in the reservoir;
a fluid temperature sensor coupled to the reservoir and configured to output a temperature signal to the control unit based on a temperature of the fluid in the reservoir;
a control unit communicatively coupled to the fill level sensor to receive the fill level signals and to the temperature sensor to receive the fluid temperature signal, wherein the control unit is configured to execute control software to analyze the temperature signal from the temperature sensor and the fill level signals from the fill level sensor and output feedback signals that are proportionate to the instantaneous levels of fluid in the reservoir, and wherein the output feedback signals differ based on whether the temperature signal is within a first temperature range corresponding a first pre-determined fluid fill level or within a second temperature range corresponding to a second pre-determined fluid fill level; and
a feedback device communicatively coupled to the control unit to effect an alert based on the feedback signals received from the control unit, wherein one or more parameters of the alert progressively changes as the reservoir fluid level rises.

16. The system of claim 15, further including a user interface coupled to the control unit to display the state of the feedback device and provide user input to set one ore more parameters of the alert.

17. In a work vehicle having a system for providing a fluid fill level user feedback alert, the system comprising:
a fluid reservoir configured to receive a fluid up to a pre-determined fluid fill level;
a fill level sensor coupled to the reservoir to detect the rising fluid level within the reservoir during filling of the fluid in the reservoir, the fill level sensor configured to output real time fill level signals based on the changing instantaneous level of fluid in the reservoir;
a control unit communicatively coupled to the fill level sensor to receive the fill level signals and configured to execute control software to analyze the fill level signals received from the fill level sensor and output feedback signals that are proportionate to the instantaneous levels of fluid in the reservoir;
a feedback device communicatively coupled to the control unit to effect an alert based on the feedback signals received from the control unit, wherein one or more parameters of the alert progressively changes as the reservoir fluid level rises; and
a user interface coupled to the control unit to display the state of the feedback device and provide user input to set one or more parameters of the alert.

18. The system of claim 17, wherein the alert is at least one of an audible alarm and a visual alarm;
wherein the audible alarm is a beep or tone generated by a horn or speaker system of the work vehicle; and
wherein the visual alarm is a light indicator generated by at least one of an indicator light, a work light and a headlight of the work vehicle.

19. The system of claim 18, wherein the alarm is proportionately driven at one or more of a lower frequency, amplification or luminescence when the level of fluid in the reservoir is below the pre-determined fluid fill level, and the alarm is proportionately driven at one or more of a higher frequency, amplification or luminescence when the level of fluid in the reservoir is closer to the pre-determined fluid level.

20. The system of claim 17, further including a fluid temperature sensor coupled to the reservoir and configured to output a temperature signal to the control unit based on a temperature of the fluid in the reservoir;
wherein the control unit is configured to execute the control software to output different feedback signals to the feedback device based on whether the temperature signal received from the temperature sensor is within a first temperature range corresponding a first pre-determined fluid fill level or within a second temperature range corresponding to a second pre-determined fluid fill level.
